(19) United States
(12) Patent Application Publication
(10) Pub. No.: US 2023/0216315 A1
(43) Pub. Date: Jul. 6, 2023

(54) BATTERY CONTROL METHOD AND ELECTRONIC DEVICE

(71) Applicant: Lenovo (Beijing) Limited, Beijing (CN)

(72) Inventors: Huosheng LIAO, Beijing (CN); Yongliang WANG, Beijing (CN)

(21) Appl. No.: 17/944,124

(22) Filed: Sep. 13, 2022

(30) Foreign Application Priority Data
Dec. 31, 2021 (CN) 202111674665.7

(51) Int. Cl. H02J 7/00

(52) U.S. Cl. CPC H02J 7/0019; H02J 7/0047; H02J 7/007182

(57) ABSTRACT

A battery control method includes obtaining a first voltage value of a first battery pack of an electronic device; obtaining a second voltage value of a second battery pack of the electronic device, a rated capacity of the first battery pack being different from a rated capacity of the second battery pack; and controlling, based on the first voltage value and the second voltage value, a control switch to be turned on according to a control strategy to connect the second battery pack and the first battery pack in parallel.

### CROSS-REFERENCE TO RELATED APPLICATION

The present disclosure claims the priority of Chinese Patent Application No. 202111674665.7, filed with the State Intellectual Property Office of P. R. China on Dec. 31, 2021, the entire content of which is incorporated herein by reference.

### TECHNICAL FIELD

The present disclosure relates to the field of power control and, more particularly, to a battery control method and an electronic device.

### BACKGROUND

With the development of electronic technology, more and more smart devices use multiple batteries.

Each of the multiple batteries may have different features, e.g., capacity, nominal voltage, etc. When the multiple batteries operate in parallel, the voltages of the respective batteries may also be different during the charging and discharging process, and at this time, the high-voltage battery may cause an impact on the low-voltage battery, which may affect the service life of the battery.

### SUMMARY

In accordance with the disclosure, one aspect of the present disclosure provides a battery control method. The method includes obtaining a first voltage value of a first battery pack of an electronic device; obtaining a second voltage value of a second battery pack of the electronic device, a rated capacity of the first battery pack being different from a rated capacity of the second battery pack; and controlling, based on the first voltage value and the second voltage value, a control switch to be turned on according to a control strategy to connect the second battery pack and the first battery pack in parallel.

Also, in accordance with the disclosure, another aspect of the present disclosure provides an electronic device. The electronic device includes a battery pack group including a first battery pack and a second battery pack, a rated capacity of the second battery pack being different from a rated capacity of the first battery pack; and a controller including a control circuit and at least one control switch. The control circuit is configured to obtain a first voltage value of the first battery pack, obtain a second voltage value of the second battery pack, and based on the first voltage value and the second voltage value, control a control switch to be turned on according to a control strategy to connect the second battery pack and the first battery pack in parallel.

Also, in accordance with the disclosure, another aspect of the present disclosure provides an electronic device. The electronic device includes a battery pack group including a first battery pack and a second battery pack, a rated capacity of the second battery pack being different from a rated capacity of the first battery pack; at least one coulomb counters configured to collect a remaining power of one battery pack of the battery pack group; and a controller including a control circuit and at least one control switch. The control circuit is configured to obtain a first voltage value of the first battery pack, obtain a second voltage value of the second battery pack, and based on the first voltage value and the second voltage value, control a control switch to be turned on according to a control strategy to connect the second battery pack and the first battery pack in parallel.

### DESCRIPTION OF THE DRAWINGS

In order to illustrate the technical solutions of the embodiments of the present disclosure more clearly, the following briefly introduces the accompanying drawings used in the description of the embodiments. The drawings in the following description are only some embodiments of the present disclosure. For those of ordinary skill in the art, other drawings can also be obtained from the provided drawings without any creative effort.

FIG. 1 is a flowchart of a battery control method according to Method Embodiment 1 of the present disclosure.

FIG. 2 is a flowchart of a battery control method according to Method Embodiment 2 of the present disclosure.

FIG. 3 is a schematic circuit diagram of an electronic device applying the battery control method according to Method Embodiment 2 of the present disclosure.

FIG. 4 is a flowchart of a battery control method according to Method Embodiment 3 of the present disclosure.

FIG. 5 is a flowchart of a battery control method according to Method Embodiment 4 of the present disclosure.

FIG. 6 is a schematic circuit diagram of an electronic device applying the battery control method according to Method Embodiment 4 of the present disclosure.

FIG. 7 is a flowchart of a battery control method according to Method Embodiment 5 of the present disclosure.

FIG. 8 is a schematic circuit diagram of an electronic device applying the battery control method according to Method Embodiment 5 of the present disclosure.

FIG. 9 is a flowchart of a battery control method according to Method Embodiment 6 of the present disclosure.

FIG. 10 is a flowchart of a battery control method according to Method Embodiment 7 of the present disclosure.

FIG. 11 is a schematic structural diagram an electronic device according to Device Embodiment 1 of the present disclosure.

FIG. 12 is a schematic structural diagram of an electronic device according to Device Embodiment 2 of the present disclosure.

FIG. 13 is another schematic structural diagram of an electronic device according to Device Embodiment 2 of the present disclosure.

### DETAILED DESCRIPTION

The technical solutions in the embodiments of the present disclosure are clearly and completely described below with reference to the drawings in the embodiments of the present disclosure. The described embodiments are a part but not all of the embodiments of the present disclosure. Based on the embodiments in the present disclosure, all other embodiments obtained by those of ordinary skill in the art without creative efforts shall fall within the protection scope of the present disclosure.

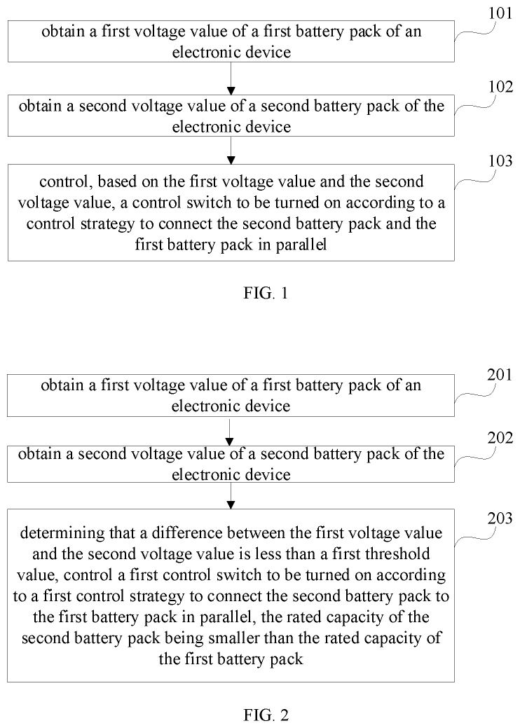

FIG. 1 is a flowchart of a battery control method according to Method Embodiment 1 of the present disclosure. The method can be applied an electronic device, and the method includes the following steps.

A controller obtains a first voltage value of a first battery pack of an electronic device (101).

In some embodiments, the electronic device has multiple battery packs, and each battery pack includes one or more batteries connected in series.

In some embodiments, the rated capacities of the first battery pack and the second battery pack are different.

The battery capacity represents the amount of electricity released by the battery under certain conditions (discharge rate, temperature, termination voltage, etc.), that is, the capacity of the battery, usually in ampere hours (Ah, 1 Ah=3600 C).

The controller obtains a second voltage value of a second battery pack of the electronic device (102).

In some embodiments, the controller can obtain the first voltage value of the first battery pack and the second voltage value of the second battery pack in the electronic device.

In some embodiments, the controller can obtain the first voltage value of the first battery pack and the second voltage value of the second battery pack periodically according to a set period.

The set period may be 10 seconds, 20 seconds, 1 minute, etc., which may be set according to actual conditions, and the specific value of the period is not limited in the present disclosure.

The controller, based on the first voltage value and the second voltage value, turns on a control switch according to a control strategy to connect the second battery pack and the first battery pack in parallel (103).

In some embodiments, the control strategy may be set in the electronic device, and the control strategy is used to control the control switch, so as to realize the parallel connection between the second battery pack and the first battery pack.

In some embodiments, the first battery pack is arranged on a first branch, the second battery pack is arranged on a second branch. The first voltage value and the second voltage value are obtained by detecting the voltages of the two branches, respectively.

In some embodiments, the control strategy can also determine the status of the battery on the corresponding branch.

For example, the first voltage value being greater than a preset value indicates that there exists a first battery pack in the first branch; and the second voltage value being greater than a preset value indicates that there exists a second battery pack in the second branch. The control strategy further includes determining whether the first battery pack and the second battery pack can be connected in parallel.

In some embodiments, the control switch may be arranged in the branch where a battery pack having a smaller capacity is located, or the control switch may be arranged in each branch where a battery pack is located.

For example, when the rated capacity of the first battery pack is relatively large, a control switch is only provided in the branch where the second battery pack is located, and the second battery pack can be connected in parallel with the first battery pack by turning on the control switch.

The battery control method provided by this embodiment includes obtaining the first voltage value of the first battery pack of the electronic device; obtaining the second voltage value of the second battery pack of the electronic device, where the rated voltage of the second battery pack is different from the rated capacity of the first battery pack; and based on the first voltage value and the second voltage value, turning on the control switch according to a control strategy to connect the second battery pack to the second battery pack in parallel. In this solution, the voltage values of the two battery packs of the electronic device are detected, and based on the voltage values of the two battery packs, the control switch is turned on according to the control strategy, so that the two battery packs can be connected in parallel As such, the two battery packs are charged in parallel or supply power in parallel to an electronic device to prevent the impact of the high-voltage battery pack on the low-voltage battery pack.

FIG. 2 is a flowchart of a battery control method according to Method Embodiment 2 of the present disclosure. The method includes the following steps.

A controller obtains a first voltage value of a first battery pack of an electronic device (201).

The controller obtains a second voltage value of the second battery pack of the electronic device (202).

The controller determines that the difference between the first voltage value and the second voltage value is less than a first threshold value, the controller turns on the first control switch according to the first control strategy to connect the second battery pack to the first battery pack in parallel (203).

In some embodiments, the rated capacity of the second battery pack is smaller than the rated capacity of the first battery pack.

In some embodiments, the first battery pack may have a relatively large rated capacity, and a large-capacity battery is generally used preferentially by default. Therefore, the first control switch is arranged in the branch where the second battery pack is located.

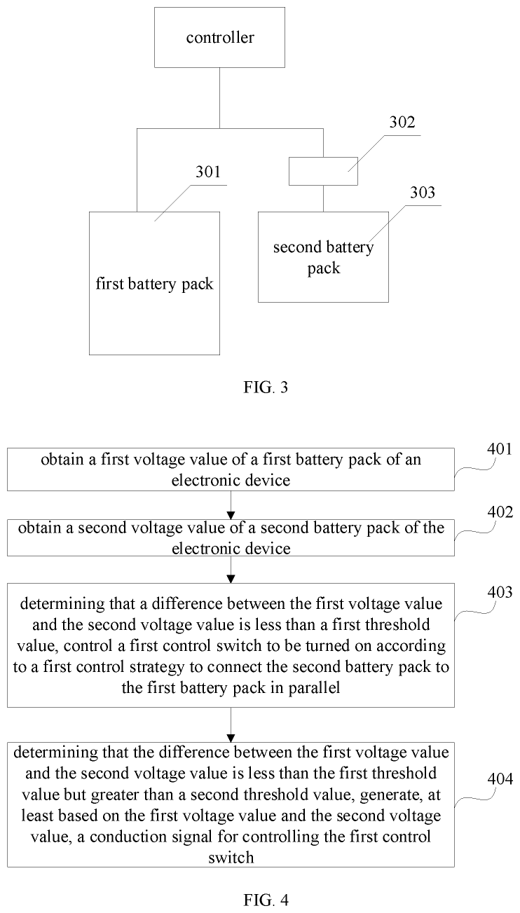

FIG. 3 is a schematic circuit diagram of an electronic device involved in this embodiment. The electronic device includes a first branch, a second branch, and a controller. The first branch is provided with a first battery pack 301, and the second branch is provided with a first control switch 302 and a second battery pack 303. In some embodiments, when the controller controls the first control switch 302 to be turned on, the second battery pack 303 is connected in parallel with the first battery pack 301, and the battery packs are connected in parallel to a system. When the controller controls the first control switch 302 to be turned off, only the first battery pack 301 is connected to the system.

The first control strategy may be a control strategy corresponding to a circuit in which a control switch is only provided in the branch where the second battery pack is located.

For example, the first control switch is turned on only when the voltage difference between the high-voltage battery pack and the low-voltage battery pack is less than the first threshold value. As such, the impact of the high-low voltage difference on the low-voltage battery pack can be reduced.

In some embodiments, the first control switch is in an off state by default. After the second battery pack is inserted into the installation position, the first control switch is turned on only when the voltage difference between the second battery pack and the first battery pack is detected to be smaller than the first threshold value.

In some embodiments, after the second battery pack is connected in parallel with the first battery pack, the method further includes the following steps.

Determining that the difference between the first voltage value and the second voltage value is greater than the first threshold value, the controller turns off the first control switch according to the first control strategy to release the second battery pack from connecting with the first battery pack in parallel (204).

When the first battery pack and the second battery pack are connected in parallel to supply power or to be charged by an external power, the controller continues to detect the voltage values of the two battery packs.

For example, if the difference between the voltage values of the two battery packs is greater than the first threshold value, the first control switch is turned off according to the first control strategy, so that the second battery pack is no longer connected to the system, and the parallel connection relationship between the second battery pack and the first battery pack is ended, thereby preventing the impact of the high-voltage battery pack on the low-voltage battery pack.

In the battery control method provided by this embodiment, based on the first voltage value and the second voltage value, turning on a control switch according to a control strategy to connect the second battery pack to the first battery pack in parallel, includes the following step. Determining that the difference between the first voltage value and the second voltage value is less than a first threshold value, the controller turns on a first control switch according to a first control strategy to connect the second battery pack to the first battery pack in parallel, where the rated capacity of the second battery pack is smaller than the rated capacity of the first battery pack. In this solution, in the circuit including the first battery pack and the second battery pack, the first control switch is only set in the branch where the second battery pack having a smaller rated capacity is located, and when the voltage difference between the two battery packs is smaller than a first threshold value, the first control switch is turned on based on the first control strategy to realize the parallel connection of two battery packs. Only one control switch is needed to realize the parallel connection of the two battery packs, and it can also ensure that the impact of the high-voltage battery pack on the low-voltage battery pack is prevented, and the modification to the circuit is small and easy to implement.

FIG. 4 is a flowchart of a battery control method according to Method Embodiment 3 of the present disclosure. The method includes the following steps.

A controller obtains a first voltage value of a first battery pack of an electronic device (401).

The controller obtains a second voltage value of a second battery pack of the electronic device (402).

Determining that the difference between the first voltage value and the second voltage value is less than a first threshold value, the controller turns on the first control switch according to the first control strategy to connect the second battery pack to the first battery pack in parallel (403).

Steps 401-403 are the same as steps 201-203 in Method Embodiment 2, and are not repeated in this embodiment.

Determining that the difference between the first voltage value and the second voltage value is less than a first threshold value but greater than a second threshold value, at least based on the first voltage value and the second voltage value. The controller generates a first conduction signal for controlling the first control switch (404).

The first conduction signal can be used to control and adjust the current value of the second battery pack, so that the difference between the first voltage value and the second voltage value is smaller than a second threshold value.

In some embodiments, if the difference between the first voltage value and the second voltage value is less than the first threshold value but greater than the second threshold value, it indicates that the voltage values of the two battery packs are different, but the difference is not large. In order to further protect the low-voltage battery pack, it is necessary to perform further fine-tuning.

For example, the magnitude of the conductivity of the first control switch can be adjusted correspondingly or inversely according to the magnitude of the voltage difference between the second battery pack and the first battery pack.

In some embodiments, the first conduction signal is generated based on the first voltage value and the second voltage value. The first conduction signal is used to control the conduction of the first control switch, so as to adjust the current value of the second battery pack. The current value of the second battery pack changes, so that the difference between the voltages of the two battery packs can be reduced.

The first battery pack has a large rated capacity, the second battery pack has a small rated capacity, and when the two are connected in parallel, there can be a leveling effect between the high and low voltages. Therefore, the output current value of the second battery pack is adjusted to have the voltage of the second battery pack and the voltage of the first battery pack as equal as possible.

In one example, when the two battery packs are supplying power to the electronic device, the first conduction signal is used to control and reduce the output current of the second battery pack, so as to reduce the speed of the voltage drop of the second battery pack while the first battery pack continues to supply power with a relatively large output current. As such, the voltages of the two battery packs can be as equal as possible. In another example, when the two battery packs are being charged, the first conduction signal is used to control to increase the input current of the second battery pack to speed up the voltage increase of the second battery pack. The first battery pack has a large rated capacity, the input current of the first battery pack maintain unchanged and the voltage thereof increases steadily. As such, the voltages of the two battery packs can be as equal as possible.

In some embodiments, the conductivity of the first control switch is controllable, and the first conduction signal may be used to control the input/output current of the second battery pack by adjusting the conductivity of the first control switch.

It should be noted that the above process of adjusting the current value of the second battery pack by feedback according to the voltage values of the two battery packs is performed periodically during the power supply/charging process to ensure that the voltages of the two battery packs can be as equal as possible.

In some embodiments, the controller may also control the voltage values of the two battery packs more accurately further based on the remaining power of the two battery packs.

When the voltage values of the battery packs are obtained, the remaining powers of the two battery packs are also obtained, and the current value of the second battery pack can be determined based on the total remaining power in the two battery packs.

For example, the controller can determine the ratios of the remaining powers of the two battery packs to the total remaining power, respectively. The ratios can be taken as the ratios of the output/input current values of the two battery packs, respectively. The current value of the first battery pack can be obtained through detection. Based on the current value of the first battery pack and the ratios, the controller can calculate the current value of the second battery pack, and adjust the output/input current value by the second battery pack.

For example, if the remaining power of the first battery pack is 400 Ah and the remaining power of the second battery pack is 100 Ah, the total remaining power in the two battery packs is 500 Ah, the current ratio of the second battery pack is 100/500=20%, and the current ratio of the first battery pack should be 400/500=80%. If the current value of the first battery pack is 1 Ampere (A), the current of the second battery pack is adjusted to be 0.25 A.

The battery control method provided in this embodiment further includes the following steps. If the difference between the first voltage value and the second voltage value is less than a first threshold value but greater than a second threshold value, the controller may generate, at least based on the first voltage value and the second voltage value, a first conduction signal for controlling the first control switch. The first conduction signal is used to control and adjust the current value of the second battery pack, so that the difference between the first voltage value and the second voltage value can be smaller than a second threshold value. In this solution, the voltage values of the two battery packs are different, but the difference is not large. The conductivity of the first control switch can be adjusted. Adjusting the conductivity of the control switch can ensure that the voltages of the two battery packs can be as equal as possible.

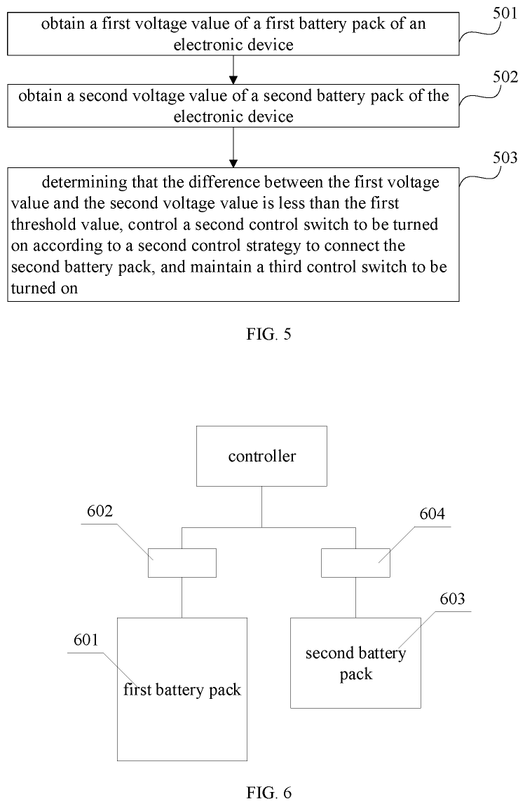

FIG. 5 shows a flowchart of a battery control method according to Method Embodiment 4 of the present disclosure. The method includes the following steps.

A controller obtains a first voltage value of a first battery pack of an electronic device (501).

The controller obtains a second voltage value of the second battery pack of the electronic device (502).

Steps 501-502 are the same as steps 101-102 in Method Embodiment 1, and are not repeated in this embodiment.

Determining that the difference between the first voltage value and the second voltage value is less than the first threshold value, the controller turns on the second control switch according to a second control strategy to connect the second battery pack to the system and maintains the third control switch to be turned on.

In some embodiments, the second control switch and the second battery pack form a second branch, and the rated capacity of the second battery pack is smaller than the rated capacity of the first battery pack.

The third control switch and the first battery pack form a first branch.

The rated capacity of the first battery pack may be relatively larger, and a large-capacity battery is generally used preferentially by default. Therefore, the second control switch is arranged on the branch where the second battery pack is located, and the third control switch is arranged on branch where the first battery pack is located.

The second control switch is turned off by default, and the third control switch is turned on by default.

The disconnection and conduction of the second control switch can realize the disconnection and connection of the second battery pack to the system. The disconnection and conduction of the third control switch can realize the disconnection and connection of the first battery pack to the system.

As shown in FIG. 6, a schematic circuit diagram of an electronic device involved in this embodiment includes a first branch, a second branch, and a controller. The first branch is provided with a first battery pack 601 and a third control switch 602. The second branch is provided with a second battery pack 603 and a second control switch 604. When the controller controls the second control switch 604 and the third control switch 602 to be turned on, the second battery pack 603 is connected in parallel with the first battery pack 601, and the two battery packs in parallel are connected to the system. When the controller controls the second control switch 604 to be turned off and controls third control switch 602 to be turned on, only the first battery pack is connected to the system.

The second control strategy is a control strategy corresponding to a circuit in which control switches are provided for the branches in which the first battery pack and the second battery pack are located, respectively.

In some embodiments, when the voltage difference between the high-voltage battery pack and the low-voltage battery pack is less than the first threshold value, the second control switch is turned on to reduce the impact of the voltage difference between the high voltage and the low voltage on the low-voltage battery pack.

The second control switch is turned off by default. After the second battery pack is inserted into the installation position, the controller turns on the second control switch only after detecting that the voltage difference between the second battery pack and the first battery pack is smaller than the first threshold value.

The second control switch is turned off by default. After the second battery pack is inserted into the installation position, the controller turns on the second control switch only after detecting that the voltage difference between the second battery pack and the first battery pack is smaller than the first threshold value.

In the battery control method provided by this embodiment, based on the first voltage value and the second voltage value, turning on a control switch according to a control strategy to connect the second battery pack to the first battery pack in parallel includes the following step. Determining that the difference between the first voltage value and the second voltage value is less than a first threshold value, the controller turns on a second control switch according to a second control strategy to connect the second battery pack to the system, where the second control switch and the second battery pack form a second branch, and the rated capacity of the second battery pack is smaller than the rated capacity of the first battery pack; and the controller also maintains the third control switch to be turned on according to the second control strategy, where the third control switch and the first battery pack form a first branch. In this solution, in the circuit including the first battery pack and the second battery pack, control switches are provided for the branches in which the first battery pack and the second battery pack are located, respectively. When the voltage difference between the two battery packs is less than the first threshold value, based on the second control strategy, the second control switch of the branch where the second battery pack is located is turned on to realize the parallel connection of the two battery packs. Only one control switch is needed to realize the parallel connection of the two battery packs, and it can also ensure that the impact of the high-voltage battery pack on the low-voltage battery pack is prevented, and the modification to the circuit is small and easy to implement.

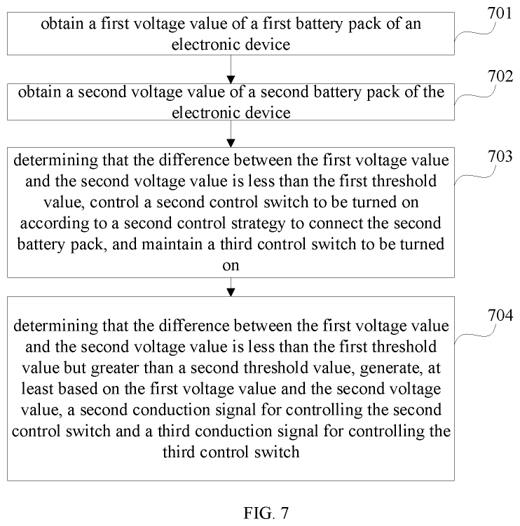

FIG. 7 is a flowchart of a battery control method according to Method Embodiment 5 of the present disclosure. The method includes the following steps.

A controller obtains a first voltage value of a first battery pack of an electronic device (701).

The controller obtains a second voltage value of the second battery pack of the electronic device (702).

Determining that the difference between the first voltage value and the second voltage value is less than the first threshold value, the controller turns on the second control switch according to the second control strategy to connect the second battery pack and maintains the connection of the third control switch (703).

Steps 701-702 are the same as steps 501-503 in Method Embodiment 4, and are not repeated in this embodiment.

Determining that the difference between the first voltage value and the second voltage value is less than a first threshold value but greater than a second threshold value, the controller generates, at least based on the first voltage value and the second voltage value, a second conduction signal of the second control switch and the third conduction signal of the third control switch.

For example, the second conduction signal is used to control the output current value of the second battery pack, and the third conduction signal is used to control the output current value of the first battery pack, so that the difference between the first voltage value and the second voltage values can be smaller than the second threshold value.

This embodiment is an explanation of the control method for the process of two battery packs supplying power to an electronic device.

When the two battery packs are supplying power to the electronic device, the two battery packs output currents, respectively.

In some embodiments, if the difference between the first voltage value and the second voltage value is less than the first threshold value but greater than the second threshold value, it indicates that the voltage values of the two battery packs are different, but the difference is not large. In order to further protect the low-voltage battery pack, it is necessary to perform further fine-tuning.

The first battery pack has a large rated capacity, the second battery pack has a small rated capacity, and when the two are connected in parallel, there can be a leveling effect between the high and low voltages. Therefore, the current values output by the two battery packs are adjusted, respectively, to have the voltage of the second battery pack and the voltage of the first battery pack as equal as possible.

For example, if the first voltage value is greater than the second voltage value, the second conduction signal of the second control switch is used to control and reduce the output current of the second battery pack, and third conduction signal of the third control switch is used to control and increase the output current of the first battery pack;

For example, if the first voltage value is lower than the second voltage value, the second conduction signal of the second control switch is used to control and increase the output current of the second battery pack, and third conduction signal of the third control switch is used to control and reduce the output current of the first battery pack;

In some embodiments, when two battery packs are supplying power to the electronic device, the second conduction signal is used to control and reduce the output current of the second battery pack, so as to reduce the speed at which the voltage of the second battery pack drops. The third conduction signal is used to control and adjust the output current of the first battery pack, so as to maintain the speed at which the voltage of the first battery pack drops. As such, the voltages of the two battery packs can be as equal as possible.

In some embodiments, the conductivities of the second control switch and the third control switch are both controllable. The second conduction signal controls the output current of the second battery pack by adjusting the conductivity of the second control switch. The third conduction signal controls the output current of the first battery pack by adjusting the conductivity of the third control switch.

It should be noted that the above process of adjusting the current value of the second battery pack by feedback according to the voltage values of the two battery packs is performed periodically during the power supply process to ensure that the voltages of the two battery packs are as equal as possible.

In some embodiments, the controller may also control the voltage values of the two battery packs more accurately further based on the remaining power of the two battery packs.

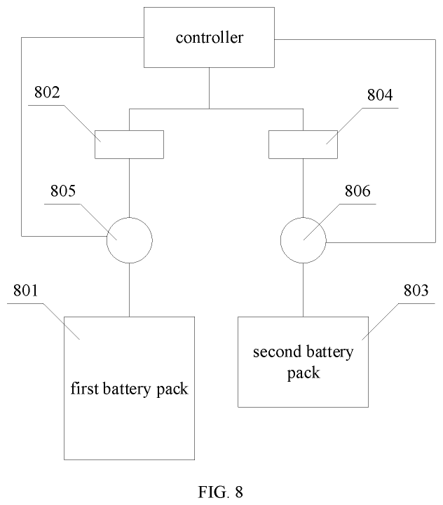

FIG. 8 is a schematic circuit diagram of an electronic device involved in this embodiment. The electronic device includes a first branch, a second branch and a controller. The first branch is provided with a first battery pack 801 and a third control switch 802, and the second branch is provided with a second battery pack 803 and a second control switch 804. When the controller controls both the second control switch 804 and the third control switch 802 to be turned on, the second battery pack 803 is connected in parallel with the first battery pack 801, and the battery packs in parallel are connected to the system. When the controller controls the second control switch 804 to turn off and controls third control switch 802 to be turned on, only the first battery pack 801 is connected to the system. A first coulomb counter 805 is also arranged in the first branch, and the first coulomb counter 805 is used to detect the remaining power of the first battery pack 801. A second coulomb counter 806 is arranged at the second branch, and the second coulomb counter 806 is used to detect the remaining power of the second battery pack 803. The two coulomb counters send the detected remaining powers to the controller, so that the controller performs control in combination with the remaining power of the two battery packs.

When the voltage values of the two battery packs are obtained, the remaining powers of the two battery packs are also obtained, and the current values of the first battery pack and the second battery pack can be determined based on the total remaining power in the two battery packs.

For example, the ratios of the remaining powers of the two battery packs to the total remaining power is determined, respectively. The ratios are taken as the ratios of the output current values of the two battery packs, respectively. Based on the current value required by the power structure, the current values output by the two battery packs can be determined, and the current values output by the two battery packs can be adjusted.

For example, based on the current ratio and in combination with the rated current value of the battery, the conductivity of the control switch in each branch can be adjusted, so as to adjust the output current of the corresponding battery pack.

The remaining power of the first battery pack is A, the remaining power of the second battery pack is B, the total power is A+B, the output current ratio of the first battery pack is A/(A+B), the output current ratio of the second battery pack is B/(A+B). The current required by the power structure is C, then the output current value of the first battery pack is AC/(A+B), and the output current value of the second battery pack is BC/(A+B)

The rated current value that can be provided by the first battery pack is a, and the rated current value that can be provided by the second battery pack is b.

Then, in the branch where the first battery pack is located, the conductivity of the third control switch is AC/(A+B)/a; and in the branch where the second battery pack is located, the conductivity of the second control switch is BC/(A+B)/b.

For example, the remaining power in the first battery pack is 400 Ah, the remaining power in the second battery pack is 100 Ah, the total remaining power in the two battery packs is 500 Ah, and the current ratio of the second battery pack is 100/500=20%, the current ratio of the first battery pack should be 400/500=80%. If the current required by the current power structure is 1 A, then the output current of the first battery pack is adjusted to 0.8 A, and the output current of the second battery pack is adjusted to 0.2 A. The rated current of the first battery pack is 2 A, then the conductivity of the third control switch is adjusted to 40%, so that the output current of the first battery pack to the power system through the third control switch can be adjusted to 0.8 A×(2×0.4). The rated current of the second battery pack is 1 A, then the conductivity of the second control switch is adjusted to 20%, so that the output current of the second battery pack to the power system through the second control switch can be adjusted to 0.2 A×(1×0.2).

In the battery control method provided in this embodiment, when the first battery pack and the second battery pack are supplying power to an electronic device, determining that the difference between the first voltage value and the second voltage value being less than a first threshold value and greater than a second threshold value, the controller controls, at least based on the first voltage value and the second voltage value, the second conduction signal of the second control switch and the third conduction signal of the third control switch. The second conduction signal is used to control the output current value of the second battery pack, and the third conduction signal is used to control the output current value of the first battery pack, so that the difference between the first voltage value and the second voltage values can be smaller than the second threshold value. In this solution, the voltage values of the two battery packs are different, but the difference is not large. The conductivities of the control switches in the branches where the two battery packs are located can be adjusted, respectively. By adjusting the conductivities of the two control switches, the output current of the two battery packs can be adjusted to ensure that the voltages of the two battery packs are as equal as possible.

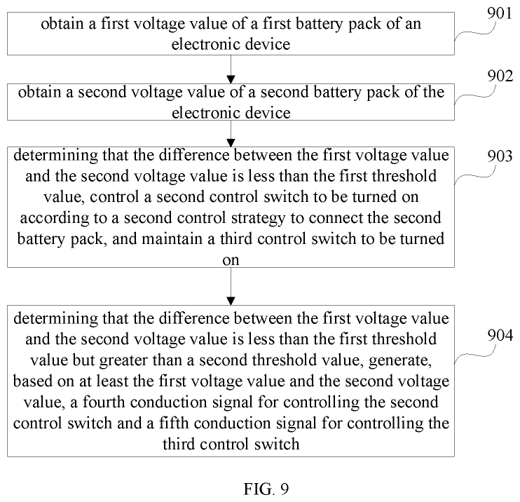

FIG. 9 is a flowchart of a battery control method according to Method Embodiment 6 of the present disclosure. The method includes the following steps.

A controller obtains a first voltage value of a first battery pack of an electronic device (901).

The controller obtains a second voltage value of the second battery pack of the electronic device (902).

Determining that the difference between the first voltage value and the second voltage value is less than the first threshold value, the controller turns on the second control switch according to the second control strategy to connect the second battery pack, and maintains the third control switch to be turned on (903).

Steps 901-903 are the same as steps 501-503 in Method Embodiment 4, and are not repeated in this embodiment.

Determining that the difference between the first voltage value and the second voltage value is less than a first threshold value and greater than a second threshold value, the controller generates, based on at least the first voltage value and the second voltage value, a fourth conduction signal of the second control switch and a fifth conduction signal of the third control switch.

The fourth conduction signal is used to control the input current value of the second battery pack, and the fifth conduction signal is used to control the input current value of the first battery pack, so that the difference between the first voltage value and the second voltage value can be smaller than the second threshold value.

Among them, this embodiment is an explanation of the control method implemented in the process of charging two battery packs by an external power source.

For example, when the first battery pack and the second battery pack are being charged, each of the two battery packs receives current provided by an external power source, and each of the two battery packs has an input current.

In some embodiments, if the difference between the first voltage value and the second voltage value is less than the first threshold value and greater than the second threshold value, it indicates that the voltage values of the two battery packs are different, but the difference is not large. In order to further protect the low-voltage battery pack, it is necessary to perform further fine-tuning.

The first battery pack has a large rated capacity, the second battery pack has a small rated capacity, and when the two are connected in parallel, there can be a leveling effect between the high and low voltages. Therefore, the current values output by the two battery packs are adjusted, respectively, to have the voltage of the second battery pack and the voltage of the first battery pack as equal as possible.

If the first voltage value is greater than the second voltage value, the fourth conduction signal of the second control switch is used to control and increase the input current of the second battery pack, and the fifth conduction signal of the third control switch is used to control and reduce the input current of the first battery pack;

If the first voltage value is smaller than the second voltage value, the fourth turn-on signal of the second control switch is used to control and reduce the input current input of the second battery pack, and the fifth conduction signal of the third control switch is used to control and increase the input current of the first battery pack.

When the two battery packs are being charged, the fourth conduction signal is used to control and adjust the input current of the second battery pack to adjust the speed at which voltage of the second battery pack rises, and the third conduction signal is used to control and adjust output current of the first battery pack to adjust the speed at which the voltage of the first battery pack drops. As such, the voltages of the two battery packs can be as equal as possible.

In some embodiments, the conductivities of the second control switch and the third control switch are both controllable. The fourth conduction signal is to control the input current of the second battery pack by adjusting the conductivity of the second control switch. The fifth conduction signal is to control the input current of the first battery pack by adjusting the conductivity of the third control switch.

It should be noted that the above process of adjusting the current value of the second battery pack by feedback according to the voltage values of the two battery packs is performed periodically during the charging process to ensure that the voltages of the two battery packs are as equal as possible.

In some embodiments, in order to control the voltage values of the two battery packs more accurately, the control may also be performed in combination with the remaining power of the two battery packs.

In some embodiments, the remaining power of the battery pack can be detected by the coulomb counter provided at its corresponding branch. The structure of the circuit is shown in FIG. 8.

When the voltage values of the battery pack are obtained, the remaining powers of the two battery packs are also obtained, respectively, and the current value of the second battery pack can be determined based on the total remaining power in the two battery packs.

For example, the ratios of the remaining power of the two battery packs to the total remaining power can be determined, respectively. The ratios are taken as the ratios of the input current values of the two battery packs, respectively. Based on the current value that the power supply can provide and the ratios, the current value of the second battery pack can be calculated, and the input current value by the second battery pack can be adjusted.

The remaining power of the first battery pack is A, the remaining power of the second battery pack is B, the total power is A+B, the output current ratio of the first battery pack is A/(A+B), the output current ratio of the second battery pack is B/(A+B). The current provided by the power supply is D, then the input current value of the first battery pack is AD/(A+B), and the input current value of the second battery pack is BD/(A+B).

The maximum current value that the first battery pack can receive is c, and the maximum current value that the second battery pack can receive is d.

Then, in the branch where the first battery pack is located, the conductivity of the third control switch is AD/(A+B)/c; and in the branch where the second battery pack is located, the conductivity of the second control switch is BD/(A+B)/d.

For example, the remaining power in the first battery pack is 400 Ah, the remaining power in the second battery pack is 100 Ah, the total remaining power in the two battery packs is 500 Ah, the current ratio of the second battery pack is 100/500=20%, and the current ratio of the first battery pack should be 400/500=80%.

If the current provided by the power supply is 2 A, the input current of the first battery pack is 1.6 A, and the input current of the second battery pack is 0.4 A.

The maximum current value that the first battery pack can receive is 2 A, then the conductivity of the third control switch is adjusted to 80%, so that the current input by the first battery pack through the third control switch is 1.6 A×(2×0.8). The maximum current value that the second battery pack can receive is 1 A, then the conductivity of the second control switch is adjusted to 40%, so that the current input by the second battery pack through the second control switch is 0.4 A×(1×0.4).

The battery control method provided in this embodiment includes the following steps. If the first battery pack and the second battery pack is being charged, the controller generates, based on at least the first voltage value and the second voltage value, a fourth conduction signal of the second control switch and a fifth conduction signal of the third control switch. The fourth conduction signal is used to control the input current value of the second battery pack, and the fifth conduction signal is used to control the input current value of the first battery pack, so that the difference between the first voltage value and the second voltage value is smaller than the second threshold value. In this solution, the voltage values of the two battery packs are different, but the difference is not large. The conductivities of the control switches in the branches of the two battery packs can be adjusted, respectively. By adjusting the conductivities of the two control switches, the input currents of the two battery packs can be adjusted to ensure that the voltages of the two battery packs can be as equal as possible.

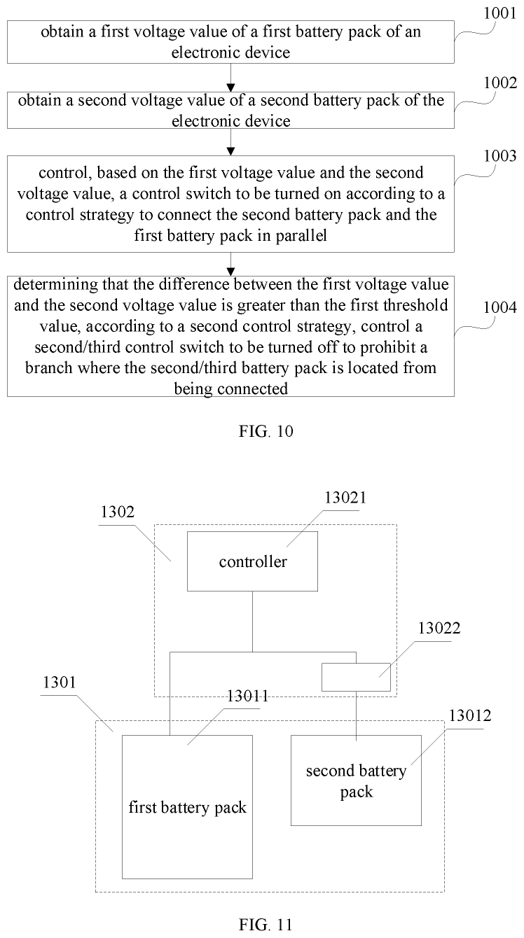

FIG. 10 is a flowchart of a battery control method according to Method Embodiment 7 of the present disclosure. The method includes the following steps.

A controller obtains a first voltage value of a first battery pack of an electronic device (1001).

The controller obtains a second voltage value of the second battery pack of the electronic device (1002).

Based on the first voltage value and the second voltage value, the controller turns on a control switch according to a control strategy to connect the second battery pack and the first battery pack in parallel (1003).

Steps 1001-1003 are the same as steps 101-103 in Method Embodiment 1, and are thus not repeated in this embodiment.

Determining that he difference between the first voltage value and the second voltage value is greater than the first threshold value, the controller turns off the second control switch/third control switch according to the second control strategy, so as to prohibit the branch where the second battery pack is located and/or the branch where the first battery pack is located from being connected to the system.

If the difference between the first voltage value and the second voltage value is smaller than the first threshold value, i.e., the voltage difference between the two battery packs is small, the controller connects the second battery pack and the first battery pack in parallel to achieve two battery packs being simultaneously changed or simultaneously supplying power to the electricity consumption structure.

If the voltage difference between the two battery packs is greater than the first threshold value, i.e., the voltage difference between the two battery packs is large, one of the battery packs needs to be disconnected, and only one of the battery packs is retained.

The second control strategy is a control strategy corresponding to a circuit in which control switches are provided for the branches in which the first battery pack and the second battery pack are located, respectively.

If the first battery pack and the second battery pack are supplying power to the electronic device, the branch where the battery pack with a lower voltage value is located is disconnected according to the second control strategy.

For example, two battery packs in the electronic device are supplying power to the electricity consumption structure, and the two battery packs output currents, respectively. In order to level the voltage values of the two battery packs, the branch where the battery pack with the low voltage value is located is disconnected. For example, if the voltage value of the first battery pack is low, the third control switch is turned off, and only the second battery pack remains to supply power to the electronic device. If the voltage value of the second battery pack is low, the second control switch is turned off, and only the first battery pack remains to supply power to the electronic device. After disconnecting the corresponding branch of one battery pack, the controller continues to detect and compare the voltage values of the two battery packs and perform steps 1001-1004 in a loop.

If the first battery pack and the second battery pack is being charged by an external power source, the branch where the battery pack with a high voltage value is located is disconnected according to the second control strategy.

For example, two battery packs is being charged by an external power source, and the two battery packs have input currents, respectively. In order to level the voltage values of the two battery packs, the branch where the battery pack with the higher voltage value is located is disconnected. If the voltage value of the first battery pack is relatively higher, the third control switch is turned off, and only the second battery pack remains to be charged. If the voltage value of the second battery pack is higher, the second control switch is turned off, and only the first battery pack remains to be charged. After disconnecting the corresponding branch of one battery pack, the controller continues to detect and compare the voltage values of the two battery packs and perform steps 1001-1004 in a loop.

The battery control method provided in this embodiment further includes the following steps. Determining that the difference between the first voltage value and the second voltage value being greater than the first threshold value, the controller turns off the second control switch/third control switch according to the second control strategy, so as to prohibit the branch where the second battery pack is located and/or the branch where the first battery pack is located from being connected to the system. In this solution, when the voltage difference between the two battery packs is greater than the first threshold value, the control switch in a branch of one of the battery packs is turned off, so as to prohibit the access of the branch where the battery pack is located. As such, the remaining battery pack is charged or the electronic device is powered only by the remaining battery pack, so that the voltage difference between the two battery packs can be reduced.

Corresponding to the above embodiments of the battery control method provided by the present disclosure, the present disclosure also provides embodiments of electronic devices applying the battery control method.

FIG. 11 is a schematic structural diagram an electronic device according to Device Embodiment 1 of the present disclosure. The electronic device includes a battery pack group 1101 and a controller 1102.

The battery pack group 1101 includes a first battery pack 11011 and a second battery pack 11012, and the rated capacity of the second battery pack 11012 is different from the rated capacity of the first battery pack 11011.

The controller 1102 includes a controller circuit 11021 and at least one control switch 11022. The controller circuit 11021 is configured to obtain a first voltage value of a first battery pack 11011 of the electronic device, and obtain a second voltage value of a second battery pack 11012 of the electronic device. Based on the first voltage value and the second voltage value, the control circuit 11021 turns on the control switch 11022 according to a control strategy to connect the second battery pack 11012 and the first battery pack 11011 in parallel.

The electronic device has multiple battery packs, and each battery pack includes one or more batteries connected in series.

The rated capacities of the first battery pack and the second battery pack are different, so when the two battery packs have the same output/input current, the voltage drop/rise speeds of the two battery packs are different.

As shown in FIG. 11, the control switch 11022 is disposed in the branch where the second battery pack 11012 is located, and the specific implementation is not limited to this.

If there is only one control switch, the control switch is turned off by default, and the control switch is provided at the branch where the battery pack with the smaller rated capacity is located;

If there are multiple control switches, each of the branches where the battery packs are located is provided a control switch.

The controller 1102 may adopt a structure such as a central processing unit (CPU) or a controller in a System-on-Chip (SOC).

The functions of the controller 1102 refer to the explanations in the foregoing method embodiments, which are not repeated in this embodiment.

The electronic device provided by this embodiment has two battery packs with different rated capacities. Based on the voltage values of the two battery packs, the controller turns on the control switch according to the control strategy, so that the two battery packs are connected in parallel. As such, the two battery packs can be charged in parallel or provide power in parallel for an electronic device, so as to prevent the impact of a high-voltage battery pack on a low-voltage battery pack.

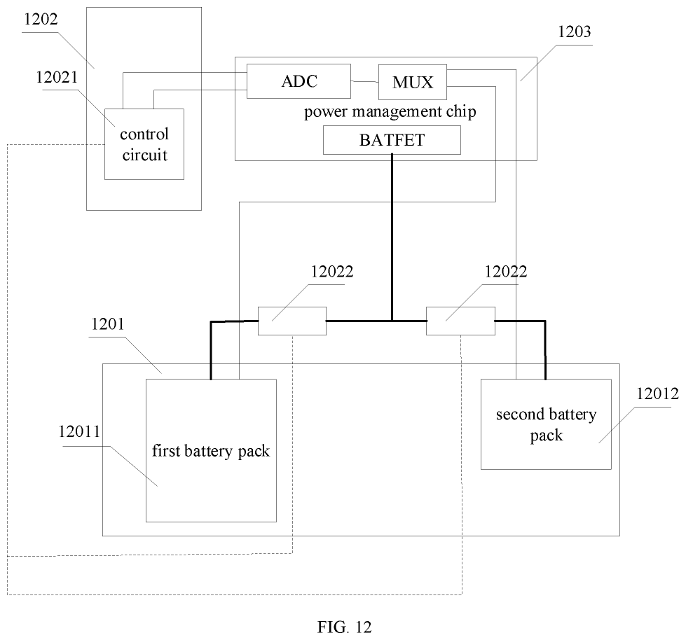

FIG. 12 is a schematic structural diagram of an electronic device according to Device Embodiment 2 of the present disclosure. The electronic device includes a battery pack group 1201, a controller 1202, and a power management chip 1203.

The structures and functions of the battery pack group 1201 and the controller 1202 are the same as those in Device Embodiment 1, and are not repeated in this embodiment.

The power management chip 1203 is connected with each battery pack of the battery pack group 1201, and is connected with the controller 1202;

The controller 1202 generates a command to detect the target branch, and the power management chip 1203 controls the battery pack in the target branch to provide power based on the command. The battery pack in the target branch includes a first battery pack or a second battery pack. The controller 1202 obtains the voltage value provided in the target branch based on the power analysis collected in the target branch, and the voltage value is used as the voltage value of the battery pack in the target branch.

As shown in FIG. 12, the thick solid line represents the power supply line, the thin solid line represents the sampling line, and the broken line represents the control line.

The two battery packs supply power to electronic devices, e.g., SOC. The power management chip is connected to the positive terminal of each battery pack, and is used to sample the voltage value of the corresponding battery pack. The controller controls the control switches of branches corresponding to the two battery packs, respectively.

The controller generates a command for detecting the target branch periodically according to a set period. The power management chip controls the battery pack of the corresponding target branch to provide electrical energy based on the command. The controller obtains the voltage value of the target branch based on the received electrical energy analysis. The voltage value is the voltage value that the battery pack in the target branch can provide, that is, the voltage value of the battery pack.

In some embodiments, the target branch is one of a first branch where the first battery pack is located and a second branch where the second battery pack is located.

For example, the controller sequentially generates a command for detecting the first branch and a command for detecting the second branch periodically according to a set period.

The power management chip adopts a power management IC (PMIC), and the PMIC has multiple functional modules/circuits, including a system circuit switch BATFET, a multiplexer (MUX), and an Analog-to-digital converter (ADC).

In a process that a battery pack supplies power to the electronic device, when the BATFET is turned on, the battery pack provides the power to the SOC. In a process that the battery pack is charged, when the BATFET is turned off, the battery pack cannot provide the power to the SOC.

The MUX collects the electric energy of two battery packs based on the command multiplexing of the controller, and outputs the conversion result to the controller of the SOC through the AD conversion of the ADC.

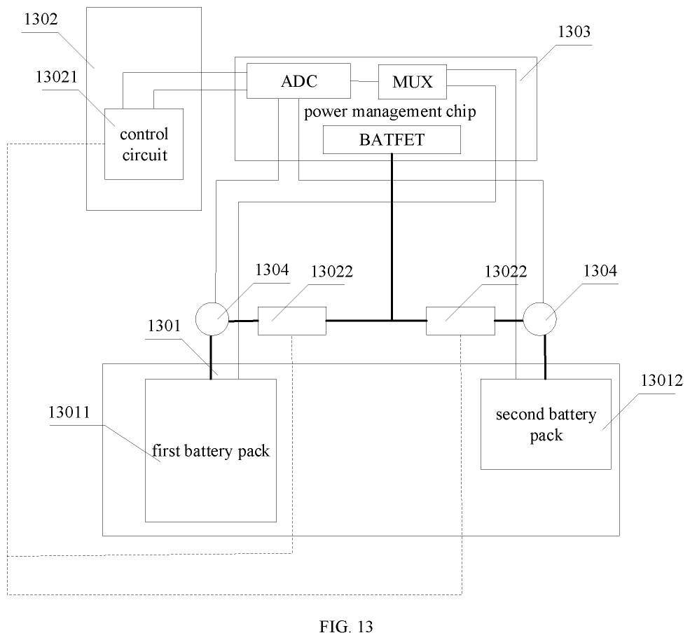

FIG. 13 is a schematic structural diagram of an electronic device according to Device Embodiment 2 of the present disclosure. The electronic device includes a battery pack 1301, a controller 1302, a power management chip 1303, and a coulomb counter 1304.

In some embodiments, two coulomb counters are provided at the branches of the battery packs, respectively. Each of the coulomb counters collects the remaining power value of each of the battery packs in the branch where they are located, respectively, and upload the collected remaining power value to the PMIC. The PMIC uploads the remaining power value to the controller, so that the controller adjusts the current output/input value of the two battery packs according to the remaining power of each of the battery pack.

The electronic device provided in this embodiment further includes a power management chip. The power management chip is connected to each battery pack of the battery pack group, and is also connected to a controller. The controller generates a command for detecting the target branch. The power management chip controls the battery pack in the target branch to provide power based on the command, where the battery pack in the target branch includes the first battery pack and/or the second battery pack. The controller obtains the voltage value provided in the target branch based on the analysis of the electric energy collected in the target branch, and the voltage value is used as the voltage value of the battery pack in the target branch. In this solution, the power management chip cooperates with the controller to collect the voltage values of each battery pack in the battery pack group, so as to control the control switches provided at the corresponding branches of the two battery packs, and to adjust the output/input current value of the connected battery packs.

The various embodiments in this specification are described in a progressive manner, and each embodiment focuses on the differences from other embodiments, and the same and similar parts between the various embodiments can be referred to each other. The devices provided in the present disclosure correspond to the methods provided by the present disclosure, the description of the devices is relatively simple, and the related part can be referred to the description of the methods.

The above description of the embodiments is provided to enable those skilled in the art to make or use the present disclosure. Various modifications to these embodiments can be readily apparent to those skilled in the art, and the generic principles defined herein may be implemented in other embodiments without departing from the spirit or scope of the present disclosure. Therefore, the present disclosure is not intended to be limited to the embodiments shown herein, but is to be accorded the widest scope consistent with the principles and novel features provided herein.

What is claimed is:

1. A battery control method comprising:
obtaining a first voltage value of a first battery pack of an electronic device;
obtaining a second voltage value of a second battery pack of the electronic device, a rated capacity of the first battery pack being different from a rated capacity of the second battery pack; and
controlling, based on the first voltage value and the second voltage value, a control switch to be turned on according to a control strategy to connect the second battery pack and the first battery pack in parallel.

2. The method of claim 1, wherein based on the first voltage value and the second voltage value, controlling the control switch to be turned on according to the control strategy includes:
determining that a difference between the first voltage value and the second voltage value is less than a first threshold value, controlling a first control switch to be turned on according to a first control strategy to connect the second battery pack to the first battery pack in parallel, the rated capacity of the second battery pack being smaller than the rated capacity of the first battery pack.

3. The method of claim 2, wherein:
determining that the difference between the first voltage value and the second voltage value is less than the first threshold value, controlling the first control switch to be turned on according to the first control strategy includes:
determining that the difference between the first voltage value and the second voltage value is less than the first threshold value but greater than a second threshold value, generating, at least based on the first voltage value and the second voltage value, a conduction signal for controlling the first control switch, the conduction signal is for controlling adjustment of a current value of the second battery pack, so that the difference between the first voltage value and the second voltage value is smaller than the second threshold value.

4. The method of claim 1, wherein based on the first voltage value and the second voltage value, controlling the control switch to be turned on according to the control strategy, includes:
determining that the difference between the first voltage value and the second voltage value is less than the first threshold value, controlling a second control switch to be turned on according to a second control strategy to connect the second battery pack; and
maintaining, according to the second control strategy, a third control switch to be turned on, wherein:
the third control switch and the first battery pack form a first branch;
the second control switch and the second battery pack form a second branch; and
the rated capacity of the second battery pack is smaller than the rated capacity of the first battery pack.

5. The method of claim 4, wherein:
the first battery pack and the second battery pack are supplying power to the electronic device; and
determining that the difference between the first voltage value and the second voltage value is less than the first threshold value, controlling the second control switch to be turned on according to the second control strategy to connect the second battery pack, includes:
determining that the difference between the first voltage value and the second voltage value is less than the first threshold value but greater than a second threshold value, generating, at least based on the first voltage value and the second voltage value, a second conduction signal for controlling the second control switch and a third conduction signal for controlling the third control switch;
wherein the second conduction signal is for controlling an output current value of the second battery pack, and the third conduction signal is for controlling an output current value of the first battery pack, so that the difference between the first voltage value and the second voltage values is smaller than the second threshold value.

6. The method of claim 4, wherein:
the first battery pack and the second battery pack are being charged; and
determining that the difference between the first voltage value and the second voltage value is less than the first threshold value, turning on the second control switch according to the second control strategy to connect the second battery pack, includes:
determining that the difference between the first voltage value and the second voltage value is less than the first threshold value but greater than a second threshold value, generating, based on at least the first voltage value and the second voltage value, a fourth conduction signal for controlling the second control switch and a fifth conduction signal for controlling the third control switch;
wherein the fourth conduction signal is for controlling an input current value of the second battery pack, and the fifth conduction signal is for controlling an input current value of the first battery pack, so that the difference between the first voltage value and the second voltage value is smaller than the second threshold value.

7. The method of claim 1, further comprising:
determining that the difference between the first voltage value and the second voltage value is greater than the first threshold value, according to a second control strategy, performing at least one of:
controlling a second control switch to be turned off to prohibit a branch where the second battery pack is located from being connected; or
controlling a third control switch to be turned off to prohibit a branch where the first battery pack is located from being connected.

8. The method of claim 7, wherein:
when the first battery pack and the second battery pack are supplying power to the electronic device, a branch where a battery pack with a lower voltage value is located is disconnected according to the control strategy; and
when the first battery pack and the second battery pack is being charged by an external power source, a branch where a battery pack with a higher voltage value is located is disconnected according to the control strategy.

9. An electronic device comprising:
a battery pack group including a first battery pack and a second battery pack, a rated capacity of the second battery pack being different from a rated capacity of the first battery pack; and
a controller including a control circuit and at least one control switch, the control circuit being configured to:
obtain a first voltage value of the first battery pack;
obtain a second voltage value of the second battery pack; and
based on the first voltage value and the second voltage value, control a control switch to be turned on according to a control strategy to connect the second battery pack and the first battery pack in parallel.

10. The electronic device of claim 9, further comprising:
a power management chip connected with each battery pack of the battery pack group and connected with the controller;
wherein:
the control circuit is further configured to generate a command to detect a target branch,
the power management chip is configured to control a battery pack in the target branch to provide power based on the command, the battery pack in the target branch including the first battery pack or the second battery pack; and
the control circuit is further configured to obtain a voltage value provided in the target branch based on a power analysis collected in the target branch, the voltage value being a voltage value of the battery pack in the target branch.

11. The electronic device of claim 9, wherein:
the at least one control switch includes a first control switch in a branch where the second battery pack is located; and
the control circuit is further configured to:
determining that a difference between the first voltage value and the second voltage value is less than a first threshold value, control the first control switch to be turned on according to a first control strategy to connect the second battery pack to the first battery pack in parallel, a rated capacity of the second battery pack being smaller than a rated capacity of the first battery pack.

12. The electronic device of claim 11, wherein the control circuit is further configured to:
determining that the difference between the first voltage value and the second voltage value is less than the first threshold value but greater than a second threshold value, at least based on the first voltage value and the second voltage value, generate a first conduction signal for controlling the first control switch, wherein the first conduction signal is for controlling adjustment of a current value of the second battery pack, so that the difference between the first voltage value and the second voltage value is smaller than the second threshold value.

13. The electronic device of claim 9, wherein the control circuit is further configured to, determining that the difference between the first voltage value and the second voltage value is less than the first threshold value:
control, according to a second control strategy, a second control switch to be turned on to connect the second battery pack; and
control, according to the second control strategy, a third control switch to be turned on;
wherein:
the third control switch and the first battery pack form a first branch;
the second control switch and the second battery pack form a second branch; and
the rated capacity of the second battery pack is smaller than the rated capacity of the first battery pack.

14. The electronic device of claim 13, wherein:
the first battery pack and the second battery pack are supplying power to the electronic device;
the control circuit is further configured to, determining that the difference between the first voltage value and the second voltage value is less than the first threshold value but greater than a second threshold value:
generate, at least based on the first voltage value and the second voltage value, a second conduction signal for controlling the second control switch and a third conduction signal for controlling the third control switch;
wherein the second conduction signal is for controlling an output current value of the second battery pack, and the third conduction signal is for controlling an output current value of the first battery pack, so that the difference between the first voltage value and the second voltage values is smaller than the second threshold value.

15. The electronic device of claim 13, wherein:
the first battery pack and the second battery pack are being charged;
the control circuit is further configured to, determining that the difference between the first voltage value and the second voltage value is less than the first threshold value but greater than a second threshold value:
generate, based on at least the first voltage value and the second voltage value, a fourth conduction signal for controlling the second control switch and a fifth conduction signal for controlling the third control switch;
wherein the fourth conduction signal is for controlling an input current value of the second battery pack, and the fifth conduction signal is for controlling an input current value of the first battery pack, so that the difference between the first voltage value and the second voltage value is smaller than the second threshold value.

16. The electronic device of claim 9, wherein determining that the difference between the first voltage value and the second voltage value is greater than the first threshold value, according to the second control strategy, the control circuit is further configured to perform at least one of:
controlling a second control switch to be turned off to prohibit a branch where the second battery pack is located from being connected; or
controlling a third control switch to be turned off to prohibit a branch where the first battery pack is located from being connected.

17. The electronic device of claim 16, wherein:
when the first battery pack and the second battery pack are supplying power to the electronic device, the control circuit is further configured to disconnect a branch where a battery pack with a lower voltage value is located according to the control strategy; and
when the first battery pack and the second battery pack is being charged by an external power source, the control circuit is further configured to disconnect a branch where a battery pack with a higher voltage value is located according to the control strategy.

18. An electronic device comprising:
a battery pack group including a first battery pack and a second battery pack, a rated capacity of the second battery pack being different from a rated capacity of the first battery pack;
at least one coulomb counters configured to collect a remaining power of one battery pack of the battery pack group; and
a controller including a control circuit and at least one control switch, the control circuit being configured to:
obtain a first voltage value of the first battery pack;
obtain a second voltage value of the second battery pack; and
based on the first voltage value and the second voltage value, control a control switch to be turned on according to a control strategy to connect the second battery pack and the first battery pack in parallel.

19. The electronic device of claim 18, wherein determining that the difference between the first voltage value and the second voltage value is greater than the first threshold value, according to the second control strategy, the control circuit is further configured to perform at least one of:
controlling a second control switch to be turned off to prohibit a branch where the second battery pack is located from being connected; or
controlling a third control switch to be turned off to prohibit a branch where the first battery pack is located from being connected.

20. The electronic device of claim 19, wherein:
when the first battery pack and the second battery pack are supplying power to the electronic device, the control circuit is further configured to disconnect a branch where a battery pack with a lower voltage value is located according to the control strategy; and
when the first battery pack and the second battery pack is being charged by an external power source, the control circuit is further configured to disconnect a branch where a battery pack with a higher voltage value is located according to the control strategy.
